(19) United States
(12) Patent Application Publication
(10) Pub. No.: US 2016/0005006 A1
(43) Pub. Date: Jan. 7, 2016

(54) COMMUNICATION SERVICES RESOURCES EVALUATION AND SCHEDULING

(71) Applicant: Verizon Patent and Licensing Inc., Arlington, VA (US)

(72) Inventors: Sengodan Subramanian, Tampa, FL (US); Mukesh Kumar, Tampa, FL (US); Chakradhar Chandaluri, Tampa, FL (US); Umashankar Velusamy, Tampa, FL (US); Hiren S. Panchal, Tampa, FL (US); Sumanta S. Rout, Tampa, FL (US)

(21) Appl. No.: 14/324,357

(22) Filed: Jul. 7, 2014

(51) Int. Cl. G06Q 10/10; G06Q 10/06; G06F 9/50

(52) U.S. Cl. CPC G06Q 10/1097; G06F 9/50; G06Q 10/063114; G06Q 10/06314

(57) ABSTRACT

A resource controller receives data identifying a communications product and determines a task associated with providing the communications product. The processor identifies human resources and network resources for performing the task, determines availabilities of the human resources and the network resources for completing the tasks, and determines a service commitment time for the particular communications product based on the availabilities of the human resources and the network resources for completing the tasks. The resource controller may display information associated with the service commitment time. The resource controller may determine a location associated with a user, and may identify communications products associated with the location. The resource controller may identify service commitment times for the available communications products, and may select one or more of the available communications products based on the service commitment times.

### BACKGROUND

In project management, a schedule will often be created as an initial step in carrying out a specific project, such as the construction of a building, development of a product, or launch of a program. Establishing a project management schedule may include listing milestones, activities, and deliverables with intended start and finish dates, of which the scheduling of employees may be an element. The production process schedule may be used for planning the production or the operation, while a resource schedule aids in the logistical planning for sharing resources among several entities. The schedule may be obtained by estimating the duration of each task and noting any dependencies amongst those tasks. Dependencies are tasks that are completed in order to make other tasks possible, such as obtaining a truck before loading materials on the truck. Scheduling of a project, therefore, may include identifying tasks necessary to complete the project, and the earliest time at which each task can be completed. In creating a schedule, a certain additional amount of time may be also considered as a contingency against unforeseen occurrences and/or delays during the project.

### BRIEF DESCRIPTION OF THE DRAWINGS

FIG. 1 shows an exemplary environment in which systems and/or methods described herein may be implemented;

FIG. 2 shows exemplary components of the device included in the environment depicted in FIG. 1;

FIG. 3 shows a schematic representation of exemplary components included in a resource controller included in the environment depicted in FIG. 1;

FIG. 4 shows an exemplary user interface presented by a user device included in the environment depicted in FIG. 1; and

FIGS. 5-7 show flow charts of an exemplary process for evaluating and scheduling resources within the environment shown in FIG. 1.

### DETAILED DESCRIPTION

The following detailed description refers to the accompanying drawings. The same reference numbers in different drawings may identify the same or similar elements.

In systems and methods described herein, a resource controller may receive data identifying a communications product and determine a task associated with providing the communications product. The controller identifies human resources and network resources for performing the task, determines availabilities of the human resources and the network resources for completing the tasks, and determines a service commitment time for the particular communications product based on the availabilities of the human resources and the network resources for completing the tasks. The resource controller may display information associated with the service commitment time. The resource controller may determine a location associated with a user, and may identify communications products associated with the location. The resource controller may identify service commitment times for the available communications products, and may select the one or more of the available communications products based on the service commitment times.

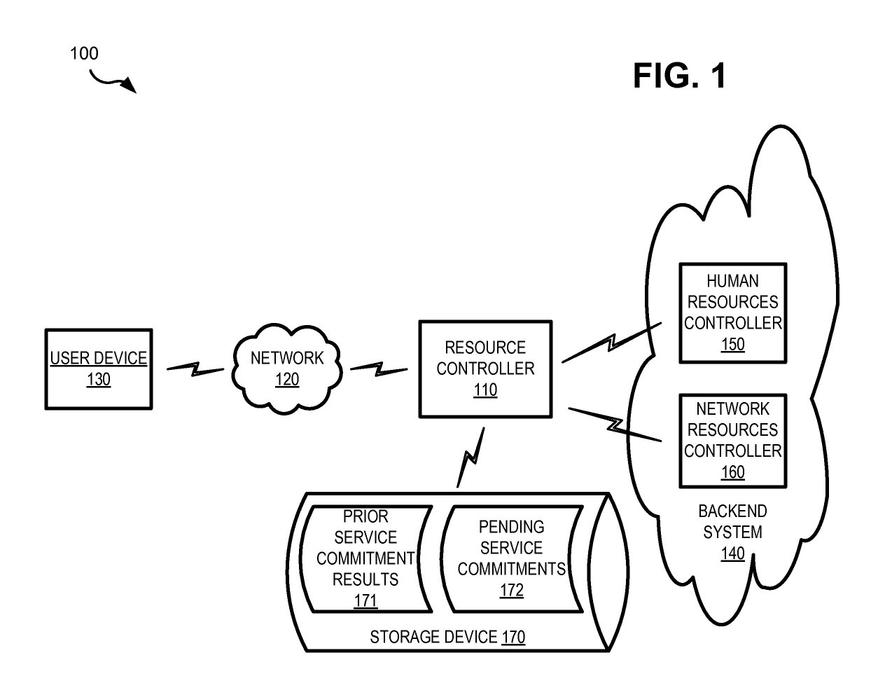

FIG. 1 shows an exemplary environment 100 in which systems and/or methods described herein may be implemented according to one implementation. As illustrated in FIG. 1, environment 100 may include, for example, a resource controller 110, a network 120, a user device 130, a backend system 140 that includes a human resources controller 150 and a network resources controller 160, and a storage device 170 that stores prior service commitment results 171 and current or pending service commitments 172.

In implementations described herein, resource controller 110 may enable a user, such as a customer or a service representative, to select (e.g., via a user interface provided by resource controller 110) goods and/or a service. Resource controller 110 may interface with components of backend system 140 to determine, for example, substantially real-time (e.g., within an hour) available levels of human, network, and hardware resources in view of current service commitments 172, and historical delays associated with prior service commitment results 171. Resource controller 110 may determine an estimated delay associating with providing the requested goods and/or services based on the resource availability and the historical delays. Resource controller 110 may further determine changes in delays based on changes in the requested goods and/or services, and may provide suggestions for changes in the requested goods and/or services to reduce the estimated delays. Resource controller 110 may additionally finalize a request for particular goods and/or services and interact with backend system to commit resources for providing the particular goods and/or services.

In one implementation, resource controller 110 may further provide an interface to receive an input from a user (e.g., from user device 130) selecting goods and/or services to be evaluated by resource controller 110, and may interact with resource controller 110 to determine and report to the user a delay associated with the selected goods and/or services.

Network 120 may be a communications network and/or data network that connect resource controller 110 to user device 130. For example, network 120 may include a local area network (LAN), a wide area network (WAN), a metropolitan area network (MAN), a wireless network, an optical fiber (or fiber optic) network, or a combination of these networks. In addition or alternatively, network 120 may be included in a radio network capable of supporting wireless communications to/from one or more devices in environment 100, and the radio network may include, for example, a long-term evolution (LTE) network, another 3rd Generation Partnership Project (3GPP) 3G/4G network, Global System for Mobile Communications (GSM), wideband code division multiple access (WCDMA), Ultra Mobile Broadband (UMB), Universal Mobile Telecommunications System (UMTS), Code Division Multiple Access 2000 (CDMA2000), High-Speed Packet Access (HSPA), Worldwide Interoperability for Microwave Access (WiMax), enhanced high-rate packet data (eHRPD), or a network implemented in accordance with future wireless network standards. In another implementation, network 120 may be included in one or more private Internet Protocol (IP) networks that use a private IP address space.

User device 130 may include any type of computation device, such as a PC, laptop computer, tablet computer, personal digital assistant, cell phone, etc., that is capable of transmitting data (e.g., emails, text messages, instant messages, facsimiles, etc.), video data (e.g., video calls, video chats, video messages, etc.) and/or voice data (e.g., voice calls) to/from a network, such as network 120.

Backend system 140 may include devices that generate and/or manage data regarding human resources (e.g., from human resource controller 150) and/or network resources (e.g., from network resources controller 160). For example, backend system 140 may monitor the status of human resources and network resources and identify when the human resources and network resources are in use or are available to be allocated to a new task.

As shown in FIG. 1, environment 100 may further include a storage device 170 that stores information that may include, among other things, prior service commitment results identifying delays associated with fulfilling prior service commitments and pending service commitments 172 identifying unfulfilled pending service commitments. Storage device 170 may include, for example, one or more data storage media, devices, or configurations and may employ any type, form, and combination of storage media. For example, storage device 170 may include, but is not limited to, a hard drive, network drive, flash drive, magnetic disc, optical disc, or other non-volatile storage unit.

Although FIG. 1 shows exemplary components of environment 100, in other implementations, environment 100 may include fewer components, different components, differently arranged components, or additional components than those depicted in FIG. 1. Alternatively, or additionally, one or more components of environment 100 may perform one or more other tasks described as being performed by one or more other components of environment 100. For example, resource controller 110 and backend system 140 may be combined in single system to control human and/or network resources.

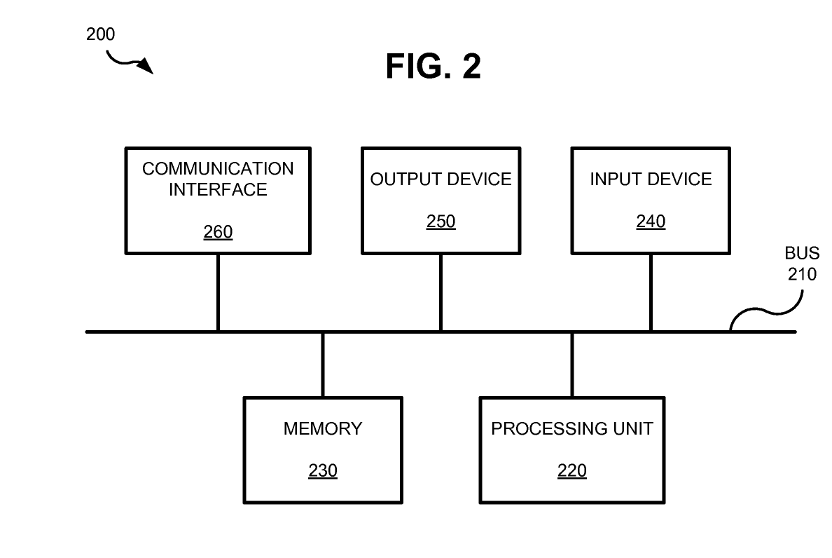

FIG. 2 is a diagram illustrating exemplary components of a device 200 that may correspond, respectively, to one or more of the components of environment 100, such as resource controller 110, a device (e.g., a node, router, server, etc.) included in network 120, user device 130, backend system 140, human resources controller 150, network resources controller 160, or storage device 170, according to one implementation. Each of the components of environment 100 may be implemented and/or installed as a combination of hardware and software on one or more respective devices 200. As shown in FIG. 2, device 200 may include, for example, a bus 210, a processing unit 220, a memory 230, one or more input devices 240, one or more output devices 250, and a communication interface 260.

Bus 210 may permit communication among the components of device 200. Processing unit 220 may include one or more processors or microprocessors that interpret and execute instructions. In other implementations, processing unit 220 may be implemented as, or include, one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits a user to input information to device 200, such as a keyboard, a keypad, a mouse, a pen, a microphone, one or more biometric mechanisms, and the like. Output device 250 may include a device that outputs information to the user, such as a display, a speaker, etc.

Communication interface 260 may include any transceiver-like mechanism that enables device 200 to communicate with other devices and/or systems. For example, communication interface 260 may include mechanisms for communicating with other devices, such as other devices of environment 100. In one implementation, communication interface 260 may support short range wireless network communications (e.g., via Bluetooth® protocols). In other implementations, communication interface 260 may support other wired or wireless network communications.

As described herein, device 200 may perform certain operations in response to processing unit 220 executing software instructions stored in a computer-readable medium, such as memory 230. A computer-readable medium may include a non-transitory tangible memory device. A memory device may be implemented within a single physical memory device or spread across multiple physical memory devices. The software instructions may be read into memory 230 from another computer-readable medium or read into memory 230 from another device via communication interface 260. The software instructions stored in memory 230 may cause processing unit 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, differently-arranged components, or additional components than those depicted in FIG. 2. As an example, in some implementations, a display may not be included in device 200. In these situations, device 200 may be a “headless” device that does not include input device 240. Alternatively, or additionally, one or more components of device 200 may perform one or more other tasks described as being performed by one or more other components of device 200.

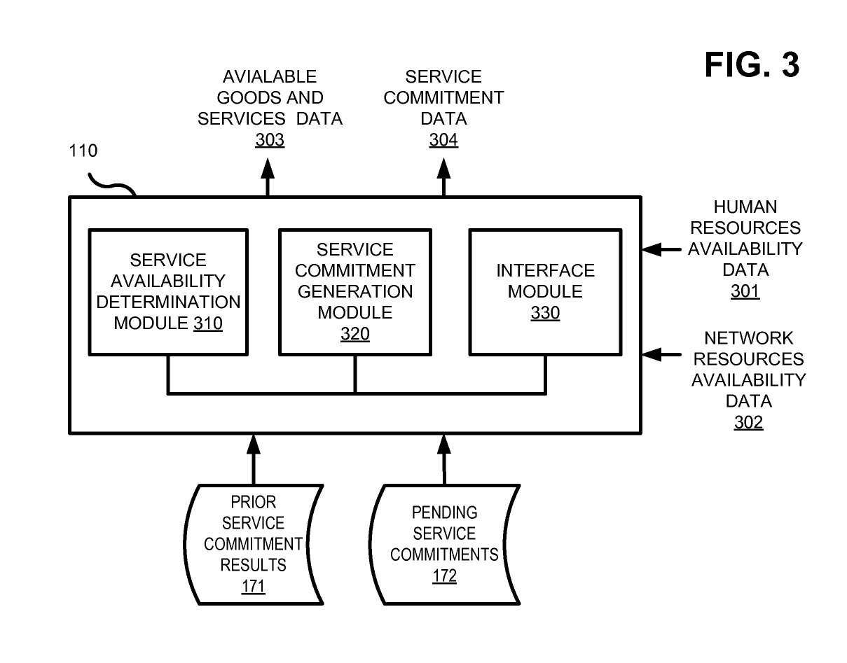

FIG. 3 shows a schematic representation of exemplary components included in resource controller 110 according to one implementation. As shown in FIG. 3, resource controller 110 may include a service availability determination module 310, a service commitment generation module 320, and an interface module 330.

Service availability determination module 310 may determine a list of available communication services provided, for example, by a local exchange carrier (LEC). For example, Service availability determination module 310 may determine information regarding a particular customer, such as an associated location and/or a customer type (e.g., whether the particular customer is a business or residential customer), and service availability determination module 310 may identify services available to the particular customer. For example, user device 130 may forward an input identifying a customer (e.g., an account number), and service availability determination module 310 may access customer profile data to identify a billing address and/or service address included in the customer profile data.

In one implementation, service availability determination module 310 may validate a customer's address and contact details. For example, availability determination module 310 may interface with a third party device to validate the customer's address and contact details. Service availability determination module 310 may further allow a customer to create credentials for future login after validation.

Service availability determination module 310 may determine a market domain associated with a customer based on a service address associated with the customer, and service availability determination module 310 may determine services available within the market domain. For example, service availability determination module 310 may store data defining one or more defined geographic boundaries, and may use the defined geographic boundaries to determine the market domain for a customer. For example, service availability determination module 310 may determine a zip code, area code, wire center, or/or local access and transport area (LATA) associated with the service address, and may further determine the market domain associated with the determined zip code, area code, wire center, or/or LATA. In another implementation, service availability determination module 310 may identify a country for a Zip or PIN code associated with the service address and may also determine the market domain associated with the country.

Service availability determination module 310 may map each market domain to a corresponding set of communications products, and each product may be mapped to one or more associated services. Service availability determination module 310 may determine whether a service is currently available, not available, or possibly available in a market domain. For, example, availability determination module 310 may determine whether a service is available based on receiving an input from user device 130 requesting information regarding the service. A service may possibly be available in a market domain if the service is planned to be introduced into the market domain in the near future. Additionally, availability determination module 310 may determine service availability status for alternate services for the market domain.

Service commitment generation module 320 may determine delays associated with performing tasks associated with providing communication services, and then generate service commitments (e.g., a timeframe for committing to provide the various communications services) based on the delays.

For example, a user (e.g., a customer or a service representative) may select communications services, and service commitment generation module 320 may determine when the selected communications services may be available to the customer. For example, service commitment generation module 320 may show service availability and corresponding technology availability for the requested services and the given location associated with the customer (e.g., the Service Address).

For example, for each selected product or service, or technological component of a product or service, service commitment generation module 320 may determine an available capacity of the show capacity availability of the product, service, or technological component. For example, service commitment generation module 320 may determine capacity availability at a first entrance office (FEO), corresponding to a switch (SW) capacity at a Switch site and/or a network-to-network interface (NNI) capacity along with an associated service edge router. Service commitment generation module 320 may determine the entrance office (EO) site and corresponding SW site derived from a network plan matrix (NPM) or other data included in network resources availability data 302 (e.g., data received from network resources controller 160). NPM may include predefined metadata from network resources controller 160 that shows preferred points of presence (POPs) for the service address associated with the customer.

In one implementation, service commitment generation module 320 may use an NPM to identify an optimized network path between the customer's service address and a network service termination for a service provider (e.g., an LEC) to provide a product and/or service to the customer. Additionally, service commitment generation module 320 may use the optimized network path to calculate efficient network cost based on physical distance, number of hops, connection fees, latency, number of regions, or other parameters. An NPM may include, for example, information identifying market domains, available service types for each market domain, available entrance office choices for each service type, and available switch sites for the corresponding entrance office.

In one implementation, service commitment generation module 320 may further determine whether the consumption or the availability of a resource reach a capacity warning threshold (CWT) and may trigger an alarm on when the consumption or the availability of a particular network resource reaches the CWT. This CWT may be configured based on a past capacity consumption trend for the service domain and the market domain.

Based on the determined availability levels, service commitment generation module 320 may estimate service enablement date(s) associated with selected products or services. For example, service commitment generation module 320 may derive the service enablement date(s) based on comparison of the availability levels to the CWT, actual capacity availability (e.g., capacity levels at the EO and/or SW Site), and/or historic average interval days taken for the given service and the corresponding applied technology. Additionally, service commitment generation module 320 may determine a standard deviation or other measure of an expected spread in the service enablement dates (e.g., to form a likely best case and a worst case service enablement date).

In one implementation, a CWT may have multiple different values or band of values, such as a green band representing average availability levels, a yellow band representing low availability levels (levels presenting additional service commitments), and a red band representing critically low availability levels (e.g., levels that may disrupt existing service commitments), and service commitment generation module 320 may determine which CWT band is currently associated with the available resource.

Service commitment generation module 320 may determine CWTs for each service type for a given market domain. For example, separate CWT values may be determined and evaluated for each service type for different Open Systems Interconnection model (OSI) network layers. For example, service commitment generation module 320 may evaluate each service type across OSI network layer 1 (the physical layer), layer 2 (the data link layer), and layer 3 (the network layer). For example, service commitment generation module 320 may determine a physical capacity of a node (e.g., a total capacity of the node as indicated by a vendor's specification) and number of spare slots available for future expansion (e.g., to expand the total capacity of the node). Similarly, service commitment generation module 320 may classify a physical capacity of network element (e.g., a node) as a combination of configured capacity that may be used for services and non-configured physical capacity corresponding to spare slots for future expansion (e.g., unavailability capacity that may be accomplished through changes in the network elements).

In determining when a service change may be implemented, service commitment generation module 320 may check a minimum capacity which must be checked at a port level for a given physical port type and build the OSI hierarchy all the way to network element level associated with the Node.

In determining whether an available capacity complies with certain CWTs, service commitment generation module 320 may permit oversubscription of capacity (e.g., so that a service commitment exceeds a CWT) for a certain network service type and/or applicable network layer. For example, service commitment generation module 320 may schedule a service change that may cause a Layer 3 CWT to be exceeded (e.g., causing excessive bandwidth) with the knowledge that excessive bandwidth may result in slower and/or less reliable transmissions.

In one implementation, service commitment generation module 320 may evaluate human resources capacity associated with the market domain. For example, service commitment generation module 320 may identify manual tasks associated with a requested product or service. For example, if a customer requests particular communications services, service commitment generation module 320 may identify particular hardware needed to provide the particular communications services and tasks associated with the particular communications services (e.g., installation of the particular hardware). Service commitment generation module 320 identifies service level agreements (SLAs) associated with the manual task, such as an expected amount of time for completing the task.

After service commitments are accepted (e.g., a customer submits an order for a service), service commitment generation module 320 may store data identifying tasks to be performed and a status of the tasks. For example, service commitment generation module 320 may monitor an amount of time taken to complete tasks (e.g., based on prior service commitment results 171), and service commitment generation module 320 may update SLAs based on the measured times. In one example, service commitment generation module 320 may update an SLA associated with a particular task if the actual measured time associated with the completion of an instance of the tasks differs from the SLA time by at least a threshold amount (e.g., by more than a standard deviation from the SLA time).

In another implementation, service commitment generation module 320 may modify human resources SLA values based on logic. For example, service commitment generation module 320 may reduce human resources SLA values by a particular amount (e.g., reducing average performance times by a particular amount (e.g., 5%) over a time period to cause improvements in the human resource performance.

In addition to predicting and measuring individual human resources SLAs, service commitment generation module 320 may form and monitor groups of human resources tasks. For example, service commitment generation module 320 may monitor human resources tasks associated with a business function, such as to evaluate human resources per product and service combination, per market domain, per network technology, and per network level for the business function. For example, service commitment generation module 320 may produce a pattern about time taken at each manual task and time taken in-total to complete all manual tasks associated with a business function. For example, service commitment generation module 320 may measure a total time taken from manual tasks related to pre-sale, ordering, pre-provisioning, provisioning, and testing activities by unit and collectively across all units.

In another example, service commitment generation module 320 may evaluate human resources per unit of time (e.g., per day) such as to evaluate human resources per market domain, per product and service combination, per network technology, per network type, and per business function. For example, service commitment generation module 320 may determine a pattern on time taken per n-units of human resources during the unit of time.

Service commitment generation module 320 may use tasks associated with a requested product and/or service and generate an expected human resource delay based on the SLAs associated with the tasks to generate a future customer desired due date (CDDD) and/or customer commitment date (CCD). For example, Service commitment generation module 320 may check existing pending customer orders for a given product and service in a market domain and may incorporate the human resource availability factor to produce a reliable service commitment date for the requested product and/or services.

Service commitment generation module 320 may further evaluate network resources associated with a market domain (e.g., from network resources availability data 302 received from network resource controller 160). For example, service commitment generation module 320 may interface with network resource controller 160 to identify a network equipment inventory and identify spare network resources and network resources being used currently used. For example, network resource controller 160 may identify, for service commitment generation module 320, provisioned and non-provisioned hardware. Service commitment generation module 320 may further evaluate capacity in a network associated with a market domain to identify whether hardware that is already installed within the market domain is already being used (e.g., in effect) or available to be assigned to a new product and/or service.

In one implementation, service commitment generation module 320 may use an NPM to identify an optimized network path between the customer's service address and network service termination for a service provider (e.g., an LEC) to provide a product and/or service to the customer, and service commitment generation module 320 may evaluate network resource availability along the optimized network path.

Thus, service commitment generation module 320 may determine service commitment data for a service and/or product by determining human resources tasks associated with providing the service and/or product and an expected time (e.g., based on the SLAs) when the human resources tasks will be completed. Service commitment generation module 320 may further verify that the needed network resources will be available during the expected time when the human resources tasks will be completed, and service commitment generation module 320 may modify the estimated service commitment date to reflect when necessary network resources will be available. Service commitment generation module 320 may further interface with backend system 140 (e.g., with human resource controller 150 and/or network resources controller 160) to commit resources to reserve and monitor the service commitment requested by a user and may further update pending service commitments 172.

Interface module 330 may provide a user interface, such as a graphical user interface (GUI), to provide user device 130 with information regarding the list of available communication services (determined by service availability determination module 310) and the service commitment dates when services and/or products will be available (generated by service commitment generation module 320). In one implementation, interface module 330 may receive an input from user device 130 regarding a selection of one or more services and may forward the selection to service commitment generation module 320 to determine an associated service commitment date. In one implementation, interface module 330 may show service availability for example, at the address, at the market domain, in a region (e.g., two or more market domains), and/or in a country.

When providing information regarding the list of available communication services determined by service availability determination module 310, interface module 330 may present a list of other products and services that are available in the location (e.g., market domain) associated with the customer. In one example, interface module 330 may present the available products and service types available across all entrance offices of market domains associated with the customer's service address. For example, interface module 330 may, based on receiving an input selecting a particular service or product, identify and present information regarding related (e.g., supplementation and/or alternative) offers. For example, if a customer is associated with a particular entrance office, interface module 330 may identify other services provided by a particular entrance office and or services provided by other entrance offices within (e.g., located less than) a particular distance.

Interface module 330 may present expected fulfillment delays associated with selected services/products. In one implementation, interface module 330, when presenting the list of other products and services that are available in the location, may also present expected fulfillment delays associated with the other products and services. In another implementation, interface module 330 may identify and present other products and services, available in the location, that are associated with expected fulfillment delays that are less than the expected fulfillment delay associated with the selected products and services. In yet another implementation, interface module 330 may identify and present other products and services, available in the location, that are associated with relatively lower pricing than the selected products and services (e.g., products and services associated with promotions).

Interface module 330 may enable a user to provide an input to modify the selected products and services. In another example, interface module 330 may connect a customer to a customer service representative to modify the selected products and services. Interface module 330 may update the service commitment date based on the modification to the selected products and services. Interface module 330 may further update the service commitment date based on results from prior service commitment results 171 to reflect changes in the human resources SLAs and/or changes in the network resources availability.

Interface module 330 may further provide pricing data associated with selected products and services and may further provide data regarding changes in pricing related to changes in the selected products and services.

Although FIG. 3 shows exemplary components of resource controller 110, in other implementations, components of resource controller 110 may include fewer components, different components, differently-arranged components, or additional components than those depicted in FIG. 3.

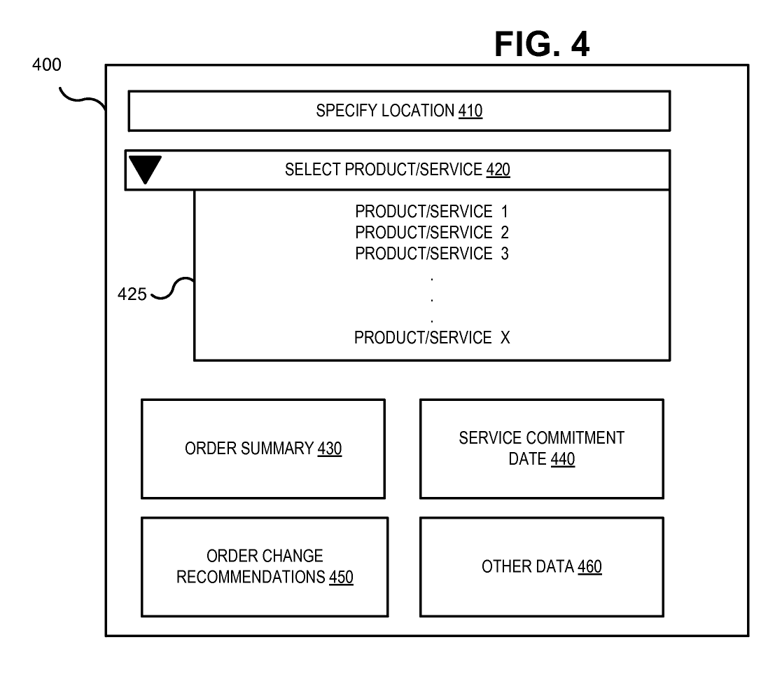

FIG. 4 shows an exemplary user interface 400 that may be presented by user device 130 according to one implementation. As shown in FIG. 4, user interface 400 may include a location field 410, a product/service selection field 420, an available products and/or services list 425, an order summary field 430, a service commitment date field 440, an order change recommendation field 450, and another data field 460.

Location field 410 may enable a user to submit an input to specify a location associated with the user or another person (e.g., a customer if the user is a service representative). For example, a user may specify a service location (e.g., address). In addition or alternatively, the user may specify a region (e.g., a city, state, or country). In another example, the user may submit data identifying a customer (e.g., an account number), and the location may be determined based on the customer identifier.

Product/service selection field 420 may enable a user to submit an input to specify a desired product and/or service. In one implementation, available products and/or services list 425 may be presented in interface 400 in connection with product/service selection field 420. Available products and/or services list 425 may be generated based on the customer's location (e.g., as identified in location field 410) or other data (such as data included in a customer profile). Available products and/or services list 425 may be generated based on the desired product and/or service specified through product/service selection field 420, such as to identify alternative products and/or services available at the location.

Order summary field 430 may identify a combination of products and/or services associated with a customer. For example, the products and/or services identified in order summary field 430 may be specified through product/service selection field 420. Order summary field 430 further include other products and/or services associated with the customer, such as pending (e.g., unfulfilled) orders associated with the customer.

Service commitment date field 440 may identify a service commitment date associated with the combination of products and/or services shown in order summary field 430. For example, as described above with respect to FIG. 3, human resource SLAs associated with tasks for delivery of the goods and services may be identified, and the SLAs may be used to estimate the service commitment date. The service commitment date may be modified based on the availability of the network resources. In one implementation, service commitment date field 440 may be updated based on inputs received in product/service selection field 420 and/or changes to order summary field 430.

Order change recommendation field 450 shows suggested products and services (e.g., selected from available products and/or services list 425. For example, order change recommendation field 450 may identify alternative products and services (e.g., competing products and services). In one example, order change recommendation field 450 may identify alternative products and services that may result in decreased costs to a customer and/or reduced service commitment days. Other data field 460 may identify other information related to interface, such as information identifying decreased costs and/or reduced service commitment days associated with the alternative products and services identified in order change recommendation field 450.

Although FIG. 4 shows exemplary components of user interface 400, in other implementations, user interface 400 may include fewer components, different components, differently-arranged components, or additional components than those depicted in FIG. 4. Alternatively or additionally, one or more components of user interface 400 may perform one or more other tasks described as being performed by one or more other components of user interface 400.

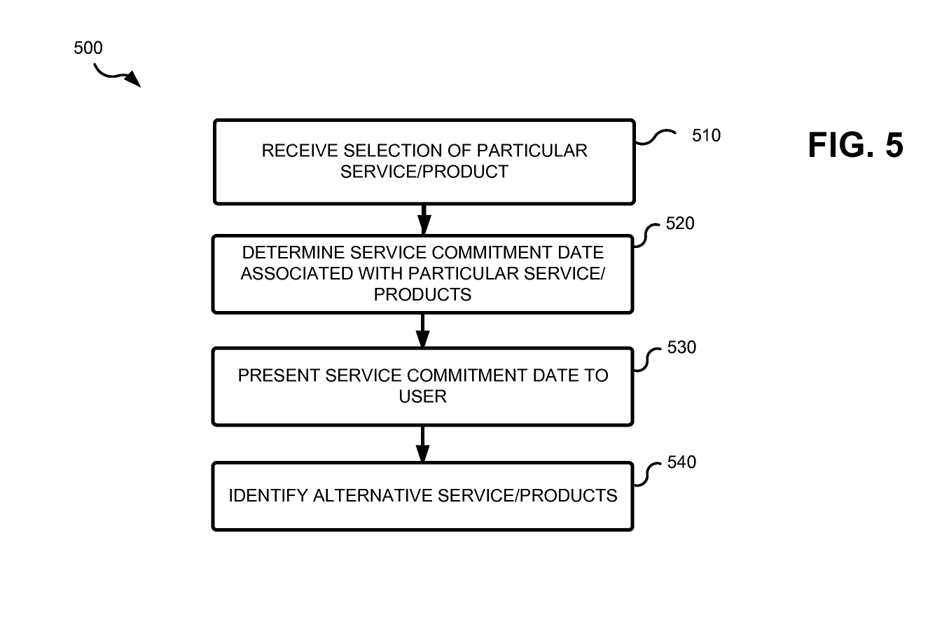

FIGS. 5-7 are flow charts of an exemplary process 500 for providing service commitment dates to a user. In one implementation, process 500 may be performed by resource controller 110. In other implementations, process 500 may be performed by a different device or by multiple devices of environment 100, such as by resource controller 110 in combination with another device. Process 500 is described with reference to components in environment 100 shown in FIG. 1.

As shown in FIG. 5, process 500 may include receiving a selection of a particular service and/or product (block 510). For example, resource controller 110 may receive an input from a user device 130 specifying the particular service and/or product. In another implementation, resource controller 110 may identify a particular service and/or product based on customer profile, such as information identifying a customer's location, the customer's prior purchases, etc.

As shown in FIG. 5, process 500 may also include determining a service commitment date associated with the particular service and/or product (block 520). For example, resource controller 110 may determine an estimated time when network hardware will be configured and available to deliver the particular service and/or product.

As shown in FIG. 5, process 500 may further present the service commitment date to a user (block 530) and identify alternative services and/or products (block 540). For example, resource controller 110 may provide a user interface to provide the service commitment date, and may also provide the alternative services and/or products in the user interface. Resource controller 110 identifies alternative services and/or products based on various criteria, such as input received via the user interface.

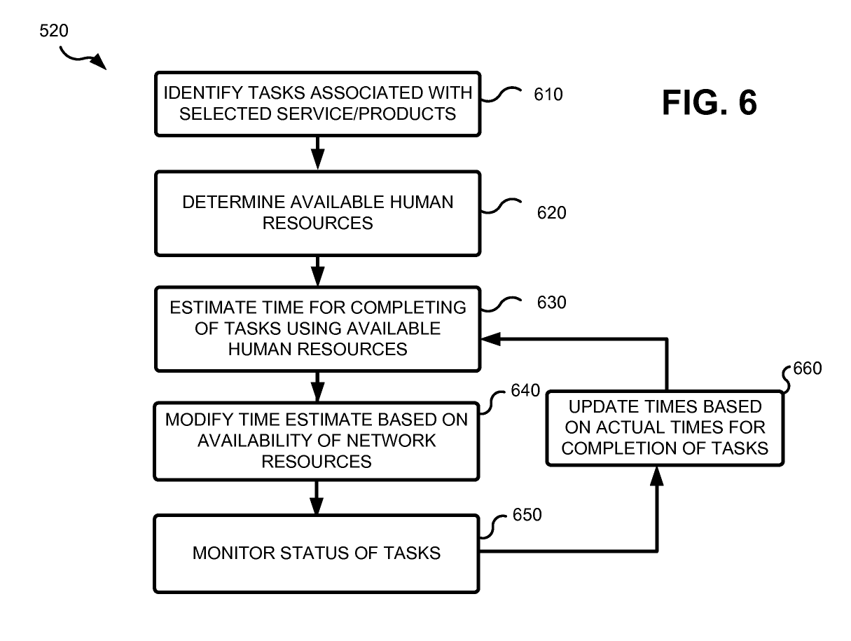

Determining the service commitment date associated with the particular service and/or product in block 520 is presented in greater detail in FIG. 6. As shown in FIG. 6, tasks associated with the selected service and/ product may be identified (block 610). For example, resource controller 110 may determine any network resources associated with the service and/or product and may further determine tasks required for making the network resources available to the customer.

As shown in FIG. 6, determining the service commitment date associated with the particular service and/or product in block 520 may further include determining available human resources (block 620), and estimating a time for completing the tasks using the available human resources (block 630). For example, resource controller 110 may interface with human resource controller 150 to determine all human resources within an area associated with the customer, and then determining which of these human resources are available (e.g., not already assigned to other tasks). Resource controller 110 may then estimate a time for completing the tasks using the available human resources based on when the human resources will be available and how long the tasks are expected to take.

As shown in FIG. 6, determining the service commitment date associated with the particular service and/or product in block 520 may still further include modifying the time estimate based on network resource availability (block 640). Resource controller 110 may interface with network resource controller 160 to identify a network equipment inventory and identify spare network resources and network resources being used currently used. For example, Resource controller 110 may identify provisioned and non-provisioned hardware., and may further evaluate capacity in a network to identify whether hardware that is already installed within the market domain is already being used (e.g., in effect) or available to be assigned to a new product and/or service. If hardware needed for a task is unavailable when a human resource is available (e.g., a network device is not available to be installed when the installer is available to perform the task), the time estimate (corresponding to the service commitment date) may be modified until the hardware becomes available.

As shown in FIG. 6, determining the service commitment date associated with the particular service and/or product in block 520 may also include monitoring the status of the tasks (block 650), and may modify the estimated times for completing the tasks by modifying actual times associated with completing one or more other tasks (block 660). For example, resource controller may collect and update the prior service commitment results 171, and use the updated prior service commitment results 171 to revise the time estimate for completing the tasks.

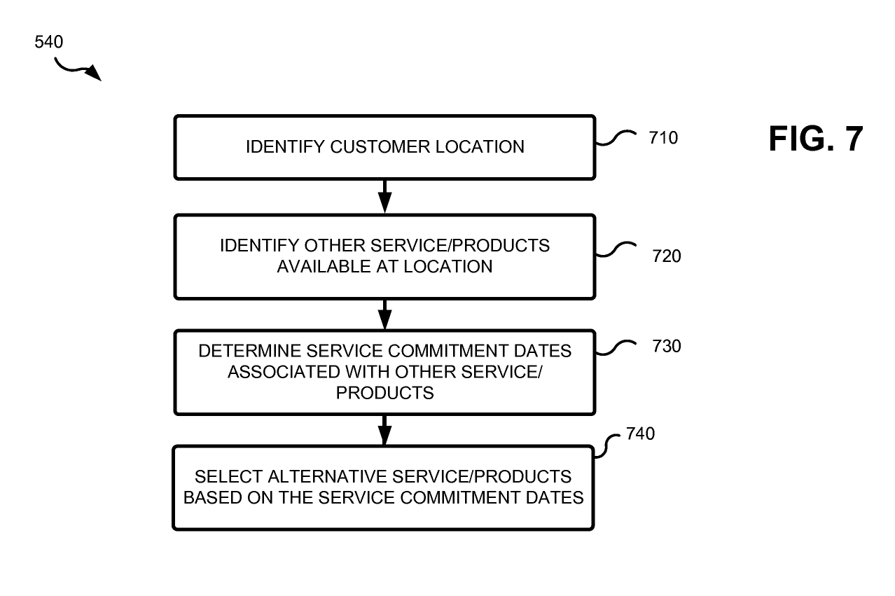

Identifying alternative services and/or products in block 540 is presented in greater detail in FIG. 7. As shown in FIG. 7, a customer's location may be identified (block 710). For example, resource controller 110 may receive an input specifying the customer's location. In another example, resource controller 110 may receive an input identifying the customer, and resource controller 110 may determine a location associated with the identified customer.

As shown in FIG. 7, identifying alternative services and/or products in block 540 may also include identifying other services and/or products that are available at the customer's location (block 720). For example, resource controller 110 may determine a market domain associated with a customer based on a service address associated with the customer, and resource controller 110 may determine services available within the market domain. Resource controller 110 may map each market domain to a corresponding set of communications products, and each product may be mapped to one or more associated services.

Continuing with FIG. 7, identifying alternative services and/or products in block 540 may further include estimating service commitment dates for the available service and/or products (block 730) and selecting the alternative service and/or products based on the service commitment dates (block 740). For example, as described above with respect to FIG. 6, resource controller 110 may determine hardware and network resources needed for the alternative service and/or products and may determine the service commitment dates based on the availability of the hardware and network resources. The alternative service and/or products may correspond to available services and/or products having shorter estimated service commitment dates than the originally selected services and/or products.

In the preceding specification, various preferred embodiments have been described with reference to the accompanying drawings. It should, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Also, while a series of blocks has been described with respect to process 500 in FIGS. 5-7, the order of the blocks in process 500 may be modified in other implementations to include additional, fewer, and/or different blocks. Further, non-dependent blocks in processes 500 may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the implementations. Thus, the operation and behavior of these aspects were described without reference to the specific software code--it being understood that software and control hardware can be designed to implement these aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving, by a processor, data identifying a particular communications product;
determining, by the processor, a task associated with providing the particular communications product;
identifying, by the processor, human resources and network resources for performing the task;
determining, by the processor, availabilities of the human resources and the network resources for completing the task;
determining, by the processor, a service commitment time for the particular communications product based on the availabilities of the human resources and the network resources for completing the task; and
providing, for display by the processor, information associated with the service commitment time.

2. The method of claim 1, wherein receiving the data identifying a communications product includes;
determining a location associated with a user; and
identifying available communications products associated with the location,
wherein the data relates to selecting the particular communications product from the available communications products.

3. The method of claim 2, further comprising:
providing for display information identifying one or more of the available communications products that differ from the particular communications product.

4. The method of claim 3, further comprising:
identifying service commitment times for the available communications products; and
selecting the one or more of the available communications products based on the service commitment times.

5. The method of claim 2, wherein determining the task associated with the providing the particular communications product includes:
identifying a network path between the location and a network service termination device associated with a service providing the particular communications product, wherein the task relates to providing the particular communications product along the network path.

6. The method of claim 1, wherein the task is included in a plurality of tasks, and wherein the method further comprises:
monitoring a time associated with completing another task included in the plurality of tasks; and
updating the service commitment time for the particular communications product based on the time associated with completing the other task.

7. The method of claim 1, wherein determining the availabilities of the human resources and the network resources includes:
identifying another task performed using at least one of the human resources or the network resources; and
determining the availabilities of the human resources and the network based on a time when the other task is completed.

8. A device comprising:
a memory configured to store information regarding a plurality of communications products; and
a processor configured to:
receive data identifying a particular communications product of the plurality of communications products,
determine, based on the information associated with the particular communications product, a task associated with providing the particular communications product,
identify human resources and network resources for performing the task,
determine availabilities of the human resources and the network resources for completing the tasks,
determine a service commitment time for the particular communications product based on the availabilities of the human resources and the network resources for completing the tasks, and
provide for display information associated with the service commitment time.

9. The device of claim 8, wherein the processor, when receiving the data identifying a communications product, is further configured to;
determine a location associated with a user, and
identify available communications products, of the plurality of communications products, associated with the location,
wherein the data relates to selecting the particular communications product from the available communications products.

10. The device of claim 9, wherein the processor is further configured to:
provide for display information identifying one or more of the available communications products that differ from the particular communications product.

11. The device of claim 10, wherein the processor is further configured to:
identify service commitment times for the available communications products, and
select the one or more of the available communications products based on the service commitment times.

12. The device of claim 9, wherein the processor, when determining the task associated with providing the particular communications product, is further configured to:
identify a network path between the location and a network service termination device associated with a service provider associated with particular communications product, wherein the task relates to providing the particular communications product along the network path.

13. The device of claim 9, wherein the task is included in a plurality of tasks, and wherein the processor is further configured to:
monitor a time associated with completing another task included in the plurality of tasks, and
update the service commitment time for the particular communications product based on the time associated with completing the other task.

14. The device of claim 8, wherein the processor is further configured to determine the availabilities of the human resources and the network resources, is further configured to:
identify another task performed using at least one of the human resources or the network resources, and
determine the availabilities of the human resources and the network based on a time when the other task is completed.

15. A computer-readable medium configured to store instruction, the instructions comprising:
one or more instructions that, when executed by a processor, cause the processor to receive data identifying a particular communications product,
determine a task associated with providing the particular communications product,
identify human resources and network resources for performing the task,
determine availabilities of the human resources and the network resources for completing the tasks,
determine a service commitment time for the particular communications product based on the availabilities of the human resources and the network resources for completing the tasks, and
provide for display information associated with the service commitment time.

16. The computer-readable medium of claim 15, wherein the one or more instructions for receiving the data identifying the communications product is further cause the processor to;
determine a location associated with a user, and
identify available communications products associated with the location,
wherein the data relates to selecting the particular communications product from the available communications products.

17. The computer-readable medium of claim 16, wherein the instructions further cause the processor:
provide, for display, information identifying one or more of the available communications products that differ from the particular communications product.

18. The computer-readable medium of claim 17, wherein the instructions further cause the processor to:
identify service commitment times for the available communications products, and
select the one or more of the available communications products based on the service commitment times.

19. The computer-readable medium of claim 16, wherein the instructions, when causing the processor to determine the task associated with providing the particular communications product, is further causes the processor to:
identify a network path between the location and a network service termination computer-readable medium associated with a service provider associated with the particular communications product, wherein the task relates to providing the particular communications product along the network path.

20. The computer-readable medium of claim 15, wherein the task is included in a plurality of tasks, and wherein the instruction further cause the processor to:
monitor a time associated with completing another task included in the plurality of tasks, and
update the service commitment time for the particular communications product based on the time associated with completing the other task.
